(19) United States
(12) Patent Application Publication
(10) Pub. No.: US 2017/0146789 A1
(43) Pub. Date: May 25, 2017

(54) LENS ARRAY MICROSCOPE

(71) Applicant: OLYMPUS CORPORATION, Tokyo (JP)

(72) Inventor: Steven Lansel, East Palo Alto, CA (US)

(21) Appl. No.: 15/425,884

(22) Filed: Feb. 6, 2017

Related U.S. Application Data
(63) Continuation of application No. PCT/US2015/052973, filed on Sep. 29, 2015.

(51) Int. Cl. G02B 21/36

(52) U.S. Cl. CPC G02B 21/367

(57) ABSTRACT

A lens array microscope includes a lens array, an illuminating unit for illuminating a sample, and an image sensing unit. The lens array includes a plurality of lenses. The sample is positioned between the illumination unit and the lens array. An image sensing unit is positioned at an image plane of the lens array, and the sample is positioned at a corresponding focal plane of the lens array. The lens array has an unfragmented field of view including a part of the focal plane.

### CROSS-REFERENCE TO RELATED APPLICATION

The present application claims priority to PCT Intl. Pat. Appl. No. PCT/US2015/052973; filed Sep. 29, 2015 (pending; Atty. Dkt. No. 52596.15WO01), the contents of which is specifically incorporated herein in its entirety by express reference thereto.

### BACKGROUND OF THE INVENTION

Technical Field

The present disclosure relates generally to optical transmission microscopy and more particularly to optical transmission microscopy using a lens array microscope.

Background

Microscopes are used in many fields of science and technology to obtain high resolution images of small objects that would otherwise be difficult to observe. Microscopes employ a wide variety of configurations of lenses, diaphragms, illumination sources, sensors, and the like in order to generate and capture the images with the desired resolution and quality. Microscopes further employ a wide variety of analog and/or digital image processing techniques to adjust, enhance, and/or otherwise modify the acquired images. One microscopy technique is optical transmission microscopy. In an optical transmission microscope, light is transmitted through a sample from one side to the other and collected to form an image of the sample. Optical transmission microscopy is often used to acquire images of biological samples, and thus has many applications in fields such as medicine and the natural sciences. However, conventional optical transmission microscopes include sophisticated objective lenses to collect transmitted light. These objective lenses tend to be costly, fragile, and/or bulky. Consequently, conventional optical transmission microscopes are less than ideal for many applications, particularly in applications where low cost, high reliability, and small size and weight are important. Accordingly, it would be desirable to provide improved optical transmission microscopy systems.

### SUMMARY

Consistent with some embodiments, a microscope includes a lens array, an illuminating unit for illuminating a sample, and an image sensing unit. The lens array includes a plurality of lenses. The image sensing unit is positioned at an image plane. The sample is then positioned at a corresponding focal plane between the illumination unit and the lens array. The lens array has an unfragmented field of view including a part of the focal plane.

Consistent with some embodiments, a microscope includes a lens array, an illuminating unit for illuminating a sample, and an image sensing unit. The lens array includes a plurality of lenses. The image sensing unit is positioned at an image plane. The sample is then positioned at a corresponding focal plane between the illumination unit and the lens array. Distances between the image sensing unit, said lens array, and said illumination unit meet a formula

$$f < b \leq \frac{2 fA}{A - 2 f} ,$$

where f is a focal length of the plurality of lenses, b is a distance between the lens array and the image sensing unit; and A is a distance between the lens array and the illumination unit.

Consistent with some embodiments, a microscope includes a microlens array, an illuminating unit for illuminating a sample, and an image sensing unit. The microlens array including a plurality of microlenses. The image sensing unit is positioned at an image plane. The sample is then positioned at a corresponding focal plane between the illumination unit and the microlens array.

### BRIEF DESCRIPTION OF THE DRAWINGS

FIG. 1A, FIG. 1B and FIG. 1C are simplified diagrams of a lens array microscope according to some examples.

FIG. 2A is a simplified plot of b/f as a function of A/f according to some examples, where b is a distance between a lens array and a sensor, f is a focal length of a plurality of lenses, and A is a distance between an illumination unit and the lens array.

FIG. 2B is a simplified plot of o as a function of A/f according to some examples, where o is an optical magnification of a lens array microscope, f is a focal length of a plurality of lenses, and A is a distance between an illumination unit and the lens array.

FIG. 3A, FIG. 3B and FIG. 3C are simplified diagrams of a test pattern and images of the test pattern according to some examples.

FIG. 4A, FIG. 4B, FIG. 4C and FIG. 4D are simplified diagrams of methods for processing images acquired using a lens array microscope according to some examples.

FIG. 5A, FIG. 5B, FIG. 5C and FIG. 5D are simplified diagrams of simulation data illustrating an exemplary image being processed by the methods of FIG. 4A, FIG. 4B, FIG. 4C and FIG. 4D according to some examples.

FIG. 5E and FIG. 5F are simplified diagrams of simulation data illustrating an exemplary image being processed by the method of FIG. 4D.

FIG. 6A and FIG. 6B are images of experimental data illustrating an exemplary image before and after being processed by the methods of FIG. 4A, FIG. 4B and FIG. 4C according to some examples.

FIG. 7 is a simplified diagram of a lens array microscope with a non-point light source according to some examples.

In the figures, elements having the same designations have the same or similar functions.

### DETAILED DESCRIPTION

In the following description, specific details are set forth describing some embodiments consistent with the present disclosure. It will be apparent to one skilled in the art, however, that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The benefits of optical transmission microscopy may be enhanced when an optical transmission microscope is constructed from low cost, highly reliable, small, and/or lightweight components. However, conventional optical transmission microscopes include sophisticated objective lenses, which tend to be costly, difficult to maintain, and/or bulky. One reason for this is objective lenses are sensitive to aberrations. To compensate for aberrations and achieve high resolution images, objective lenses tend to be constructed using a large number of carefully shaped and positioned elements in order to minimize aberrations. However, to the extent that such efforts may be successful in reducing aberrations, these efforts also tend to increase cost, fragility, size, and weight of the objective lenses.

Moreover, in a conventional microscope, a tradeoff exists between optical magnification and field of view. More specifically, the product of the optical magnification and the diameter of the field of view is a constant value, meaning that a larger optical magnification results in a smaller field of view and vice versa. One approach to compensate for the tradeoff between optical magnification and field of view of conventional optical transmission microscopes is to scan and/or step a small field of view over a large area of the sample and combine the acquired images. However, this approach typically involves high precision moving parts, sophisticated software for combining the images, and/or the like. Further difficulties with this approach include the long amount of time it takes to complete a scan, which is especially problematic when the sample moves or changes during the scan. Accordingly, scanning and/or stepping techniques are not well suited for many applications. Another approach to compensate for the tradeoff between optical magnification and field of view of conventional optical transmission microscopes is to use a two-dimensional array of objective lenses, each objective lens having a large magnification. However, because each objective lens has a large magnification and correspondingly small field of view, many microscopes with arrays of objective lenses still use scanning and/or stepping techniques in order to capture images of a large area of a sample. Yet another approach to compensate for the tradeoff between optical magnification and field of view of conventional optical transmission microscopes is to use a lensless microscope, in which a shadow cast by a sample is directly imaged by a sensor. However, the applications of lensless microscopes are limited by their extremely small working distance, which limits the available sample types and mounting techniques (e.g., many lensless microscopes are incompatible with standard glass slides), and the lack of ability to selectively image a focal plane within the sample.

Accordingly, it would be desirable to provide an optical transmission microscope that is constructed from low-cost, robust, small, and lightweight components, is capable of acquiring high resolution images, and addresses the tradeoff between optical magnification and field of view of conventional optical transmission microscopes.

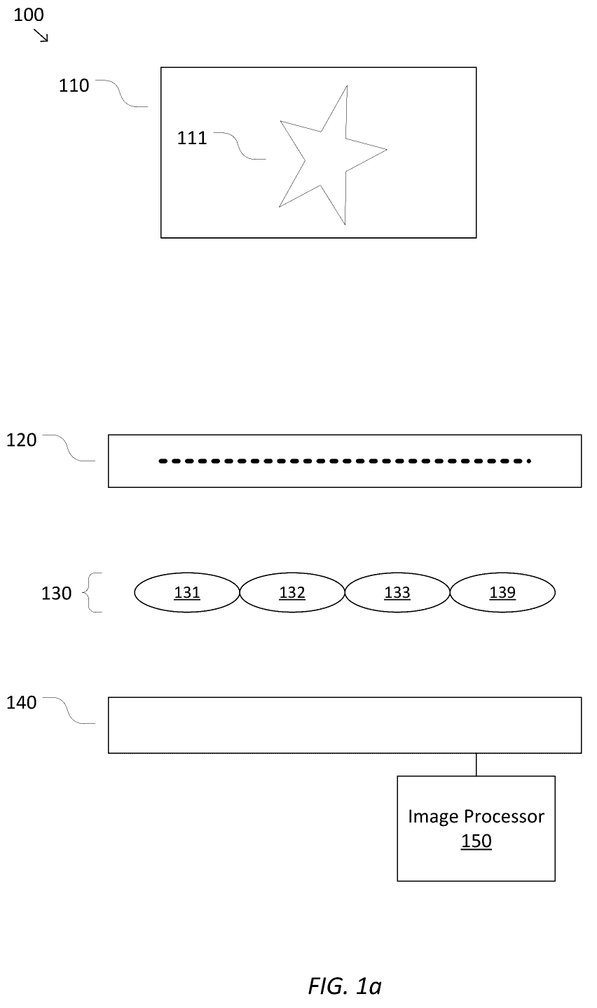

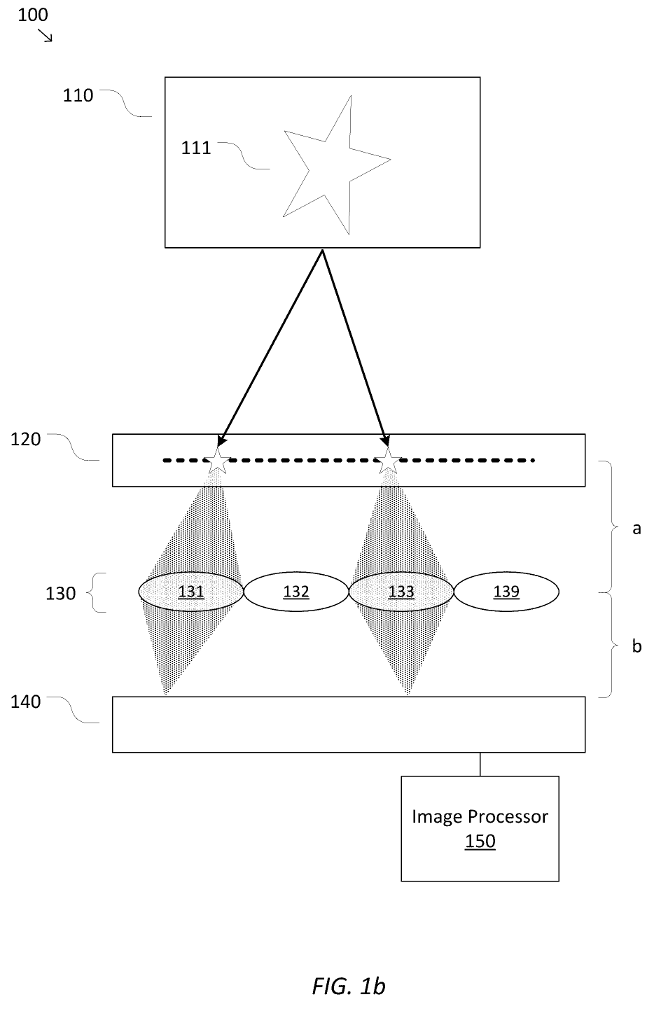

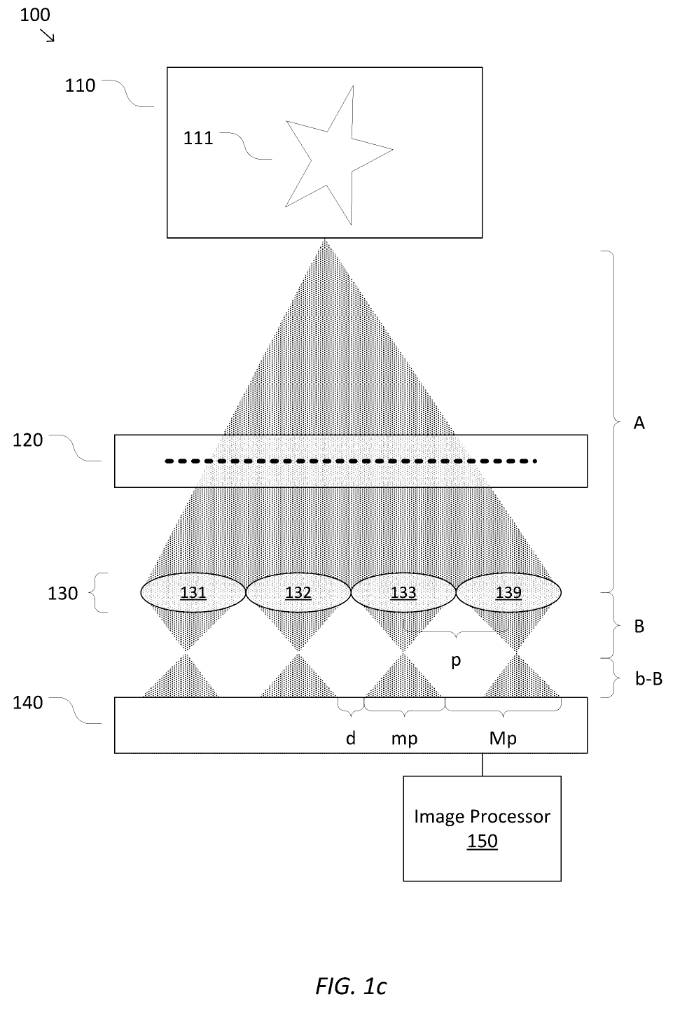

FIG. 1A, FIG. 1B and FIG. 1C are simplified diagrams of a lens array microscope 100 according to some embodiments. Lens array microscope 100 includes an illumination unit 110 positioned over a sample 120. Light from illumination unit 110 is transmitted through sample 120 and redirected by a lens array 130 onto a sensor 140. Because the light is transmitted through sample 120, the light signal that reaches sensor 140 contains information associated with sample 120. Sensor 140 converts the light signal into an electronic signal that is sent to an image processor 150.

In general, illumination unit 110 provides light to sample 120. According to some embodiments, illumination unit 110 may include a light source 111, which may include one or more sources of electromagnetic radiation including broadband, narrowband, visible, ultraviolet, infrared, coherent, non-coherent, polarized, and/or unpolarized radiation. In some examples, illumination unit 110 may support the use of a variety of light sources, in which case light source 111 may be adjustable and/or interchangeable.

According to some embodiments, illumination unit 110 may include one or more diaphragms, lenses, diffusers, masks, and/or the like. According to some embodiments, a diaphragm may include an opaque sheet with one or more apertures through which light is transmitted. For example, an aperture may be a circular hole in the opaque sheet characterized by a diameter and position, either of which may be adjustable to provide control over the apparent size and/or position of the light source. In some embodiments, the diaphragm may be adjusted in conjunction with adjustable and/or interchangeable light sources in order to adapt illumination unit 110 to various configurations and/or types of compatible light sources.

According to some embodiments, a light source lens may be used to redirect light from the light source in order to alter the apparent position, size, and/or divergence of the light source. In some examples, the lens may allow for a compact design of lens array microscope 100 by increasing the effective distance between sample 120 and the light source. That is, the lens may redirect light from a physical light source such that a virtual light source appears to illuminate sample 120 from a position more distant from sample 120 than the physical light source.

In some examples, one or more characteristics of the light source lens may be configurable and/or tunable, such as the position, focal length, and/or the like. According to some embodiments, a diffuser may be used to alter the dispersion, size, and/or angle of light from the light source to increase the spatial uniformity of the light output by illumination unit 110. According to some embodiments, a plurality of light source lenses, diaphragms, and/or additional components may be arranged to provide a high level of control over the size, position, angle, spread, and/or other characteristics of the light provided by illumination unit 110. For example, the plurality of lenses and/or diaphragms may be configured to provide Köhler illumination to sample 120.

According to some embodiments, sample 120 may include any object that is semi-transparent so as to partially transmit the light provided by illumination unit 110. According to some embodiments, sample 120 may include various regions that are transparent, translucent, and/or opaque to the incident light. The transparency of various regions may vary according to the characteristics of the incident light, such as its color, polarization, and/or the like. According to some embodiments, sample 120 may include biological samples, inorganic samples, gasses, liquids, solids, and/or any combination thereof. According to some embodiments, sample 120 may include moving objects. According to some embodiments, sample 120 may be mounted using any suitable mounting technique, such as a standard transparent glass slide.

With continuing reference to FIG. 1A, FIG. 1B and FIG. 1C, lens array 130 redirects light transmitted through sample 120 onto sensor 140. Lens array 130 includes a plurality of lenses 131-139 arranged beneath sample 120 in a periodic square pattern. According to some embodiments, lenses 131-139 are arranged in a pattern such as a periodic square, rectangular, and/or hexagonal pattern, a non-periodic pattern, and/or the like. According to still other embodiments, the lenses themselves have corresponding apertures. According to other embodiments, the lenses and/or corresponding apertures have various shapes including square, rectangular, circular, and/or hexagonal. Although lenses 131-139 are depicted as being in the same plane beneath sample 120, in some embodiments different lenses may be positioned at different distances from sample 120. Each of lenses 131-139 may be identical, nominally identical, and/or different from one another. According to some embodiments, lens array 130 may be formed using a plurality of discrete lens elements and/or may be formed as a single monolithic lens element. According to some embodiments, such as when lens array microscope 100 is designed to be portable, disposable, and/or inserted into cramped and/or hostile environments such as a human body, lens array 130 may be designed to be smaller, lighter, more robust, and/or cheaper than conventional objective lens systems. In some examples, one or more characteristics of lens array 130 and/or lenses 131-139 may be configurable and/or tunable, such as their position, focal length, and/or the like.

According to some embodiments, lenses 131-139 may be identical or similar microlenses, each microlens having a diameter less than 2 mm. For example, each microlens may have a diameter ranging between 100 μm and 1000 μm. The use of microlenses offer advantages over conventional lenses. For example, some types of microlens arrays are easy to manufacture and are readily available from a large number of manufacturers.

In some embodiments, microlens arrays are manufactured using equipment and techniques developed for the semiconductor industry, such as photolithography, resist processing, etching, deposition, packaging techniques and/or the like. By contrast, conventional lenses are often manufactured using specialized equipment, trade knowledge, and/or production techniques, which may result in a high cost and/or low availability of the conventional lenses.

In some examples, microlens arrays have simpler designs than arrays of conventional lenses, such as single element designs having a planar surface on one side of the element and an array of curved surfaces on the opposite side of the element, the curved surfaces being used to redirect incident light. In some examples, the curved surfaces form conventional lenses and/or form less conventional lens shapes such as non-circular lenses and/or micro-Fresnel lenses. Similarly, microlens arrays may use a gradient-index (GRIN) design having planar surfaces on both sides of the element. In such embodiments, the varying refractive index of the GRIN lenses rather than (and/or in addition to) curved surfaces is used to redirect incident light.

Another advantage of using microlenses includes reduced sensitivity to aberrations due to their small size. For example, the resolution of many microlenses is considered to be close to fundamental limits (e.g., diffraction limited) rather than technologically limited (e.g., limited by aberrations), thereby offering resolution comparable to highly sophisticated systems of conventional lenses without the corresponding high cost, complexity, fragility, and/or the like.

According to some embodiments, one or more of lenses 131-139 are made of glass (such as fused silica) using fabrication techniques such as photothermal expansion, ion exchange, CO₂ irradiation, and reactive ion etching. However, in some embodiments, one or more of lenses 131-139 are made of materials that are lighter, stronger, and/or cheaper than glass using techniques that are easier or cheaper than those used for glass. For example, in some embodiments, microlens arrays are manufactured using equipment and techniques developed for the semiconductor industry, such as photolithography, resist processing, etching, deposition, packaging techniques and/or the like. By contrast, conventional lenses are often manufactured using specialized equipment, trade knowledge, and/or production techniques, which may result in a high cost and/or low availability of the conventional lenses.

For example, one or more of lenses 131-139 are made of plastics or polymers having a high optical transmission such as optical epoxy, polycarbonate, poly(methyl methacrylate), polyurethane, cyclic olefin copolymers, cyclic olefin polymers, and/or the like using techniques such as photoresist reflow, laser beam shaping, deep lithography with protons, LIGA (German acronym for Lithographie, Galvanik and Abformung), photopolymerization, microjet printing, laser ablation, direct laser or e-beam writing, and/or the like. The use of such materials is particularly suitable when lenses 131-139 are microlenses due to their low sensitivity to aberrations. In some embodiments, one or more of lenses 131-139 are made of liquids.

In some embodiments, one or more of lenses 131-139 are made using a master microlens array. The master microlens array is used for molding or embossing multiple microlens arrays. In some embodiments, wafer-level optics technology is used to cost-effectively manufacture accurate microlens arrays.

Sensor 140 generally includes any device suitable for converting light signals carrying information associated with sample 120 into electronic signals that retain at least a portion of the information contained in the light signal. According to some embodiments, sensor 140 generates a digital representation of an image contained in the incident light signal. The digital representation can include raw image data that is spatially discretized into pixels. For example, the raw image data may be formatted as a RAW image file. According to some examples, sensor 140 may include a charge coupled device (CCD) sensor, active pixel sensor, complementary metal oxide semiconductor (CMOS) sensor, N-type metal oxide semiconductor (NMOS) sensor and/or the like. Preferably, the sensor has a small pixel pitch of less than 5 microns to reduce readout noise and increase dynamic range. More preferably, the sensor has a pixel pitch of less than around 1 micron.

According to some embodiments, sensor 140 is a monolithic integrated sensor, and/or may include a plurality of discrete components. According to some embodiments, the two-dimensional pixel density of sensor 140, i.e., pixels per unit area, is much larger, for example, 25 or more times larger, than the two-dimensional lens density, i.e., lenses per unit area, of lens array 130, such that a plurality of sub-images corresponding respectively to the plurality of lenses 131-139 is detected, each sub-image including a large number of pixels. According to some embodiments, sensor 140 includes additional optical and/or electronic components such as color filters, lenses, amplifiers, analog to digital (A/D) converters, image encoders, control logic, and/or the like.

Sensor 140 sends the electronic signals carrying information associated with sample 120, such as the raw image data, to image processor 150, which perform further functions on the electronic signals such as processing, storage, rendering, user manipulation, and/or the like. According to some embodiments, image processor 140 includes one or more processor components, memory components, storage components, display components, user interfaces, and/or the like. For example, image processor 140 includes one or more microprocessors, application-specific integrated circuits (ASICs) and/or field programmable gate arrays (FPGAs) adapted to convert raw image data into output image data. The output image data may be formatted using a suitable output file format including various uncompressed, compressed, raster, and/or vector file formats and/or the like. According to some embodiments, image processor 150 is coupled to sensor 140 using a local bus and/or remotely coupled through one or more networking components, and may be implemented using local, distributed, and/or cloud-based systems and/or the like.

According to some embodiments, lenses 131-139 are characterized by a focal length f. For example, a convex lens characterized by focal length f forms an image of a focal plane positioned on one side of the lens at a corresponding image plane on the opposite side of the lens. In FIG. 1B, a distance a between a first focal plane and lens array 130 and a distance b between lens array 130 and a corresponding first image plane is indicated. As depicted in FIG. 1B, sample 120 is positioned at the first focal plane and sensor 140 is positioned at the first image plane. Features of sample 120 that are positioned at the first focal plane may absorb, reflect, diffract, and/or scatter light from illumination unit 110. Accordingly, the image detected by sensor 140 includes features of sample 120 that are positioned at the first focal plane. According to some embodiments, lenses 131-139 may be modeled as thin lenses, wherein the values off a, and b are related by the following equation:

$$\frac{1}{a} + \frac{1}{b} = \frac{1}{f} \qquad Eq . 1$$

In FIG. 1C, a distance A between a second focal plane and lens array 130 and a distance B between lens array 130 and a corresponding second image plane is indicated. As depicted in FIG. 1B, illumination unit 110 is positioned at the second focal plane such that light emitted from illumination unit 110 that is transmitted through sample 120 is focused at the second image plane. When lenses 131-139 are modeled as thin lenses, the values of f, A, and B are related by the following equation:

$$\frac{1}{A} + \frac{1}{B} = \frac{1}{f} \qquad Eq . 2$$

Because the second image plane is positioned above sensor 140, the light that is focused at the second image plane spreads out before reaching sensor 140. Accordingly, each of lenses 131-139 forms an image or sub-image at sensor 140 corresponding to the region of sensor 140 illuminated by the light that was transmitted through the lens. In FIG. 1C, a distance p representing a pitch between lenses 131-139, a distance mp representing a width of a sub-image, a distance Mp representing a pitch between sub-images, and a distance d representing a width of a dark region between sub-images are indicated. In this notation, m and M represent the width and pitch of the sub-images, respectively, as measured in units of p. A value o (not shown in FIG. 1C) represents an optical magnification obtained by lens array microscope 100 where all distances are considered positive so o is not negative for inverted images. Optical magnification is a ratio of the size of an image of an object at the sensor or image plane of an imaging system over the size of the same object in the scene The above variables are related by the following equations:

$$\begin{matrix}m = \frac{b}{B} - 1 = \frac{b}{f} - \frac{b}{A} - 1 & Eq . 3 \\ M = \frac{b}{A} + 1 & Eq . 4 \\ d = ( M - m ) p = ( \frac{2 b}{A} - \frac{b}{f} + 2 ) p and & Eq . 5 \\ o = \frac{b}{a} = \frac{b}{f} - 1 & Eq . 6\end{matrix}$$

When lens array microscope 100 is modeled using the above equations, several constraints on the design of lens array microscope 100 become apparent. For example, in order for m to be positive-valued (that is, in order to form a sub-image), b is constrained to values greater than f Stated another way, if b is less than f, the lens is not powerful enough to focus the light onto the sensor from any focal plane. In some examples, in order for d to be positive-valued (that is, in order to avoid overlapping between adjacent sub-images), M is constrained to values greater than m. Together, these constraints may be algebraically manipulated to obtain the following inequality representing constraints in terms of f, A, and b:

$$f < b \leq \frac{2 fA}{A - 2 f} \qquad Eq . 7$$

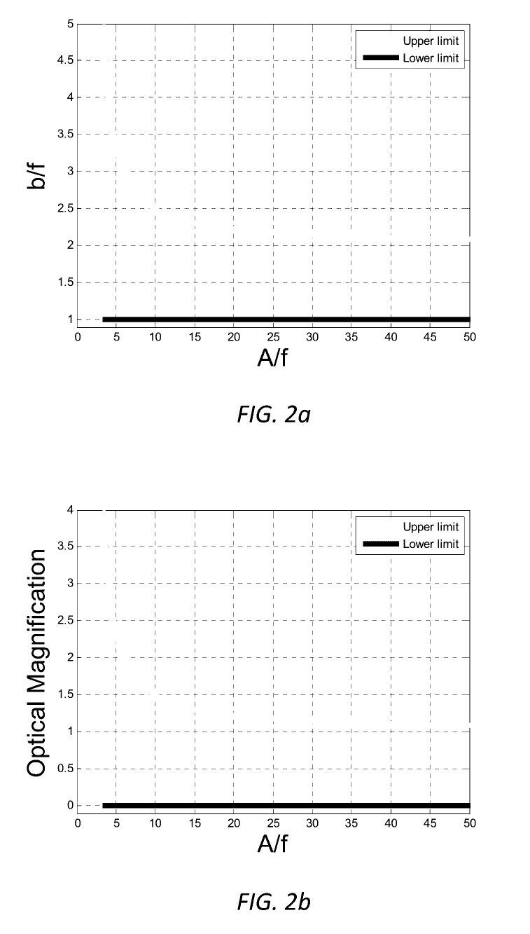

These constraints are plotted in FIG. 2A, in which b/f is plotted as a function of A/f. Based on the above inequality, some embodiments of lens array microscope 100 have b/f less than or equal to six. Other embodiments have b/f less than or equal to about 2.5. Further algebraic manipulation results in the following inequality representing constraints in terms of f A, and o:

$$0 < o \leq \frac{A + 2 f}{A - 2 f} \qquad Eq . 8$$

These constraints are plotted in FIG. 2B, in which o is plotted as a function of A/f. It is observed in FIG. 2B that o is constrained to values between zero and slightly greater than one (that is, negligible optical magnification magnitude values) when A/f is greater than or equal to about 10, and values between zero and about five (by extrapolating the upper limit curve) when A/f is greater than three. While values of A/f less than three (and a correspondingly larger optical magnification) may be achieved in various embodiments, some embodiments are constrained by practical considerations to values of A/f greater than or equal to three. For example, in some embodiments, sample 120 may occupy a finite thickness, such as when sample 120 includes a glass slide and/or another solid material. Because sample 120 is positioned between lens array 130 and illumination unit 110, the finite thickness of sample 120 may result in a minimum practical value of A/f. Furthermore, in some embodiments, placing illumination unit 110 close to sample 120 results in light propagating through sample 120 and lens array 130 at large angles with respect to the orthogonal axis of the sample and lens planes, which may result in degraded image quality.

In view of these considerations, in some embodiments, lens array microscope 100 is designed in order to account for the tradeoffs between optical magnification, image quality or resolution, and hardware constraints. Generally, in embodiments of lens array microscope 100, higher resolution is achieved more by a higher resolution sensor than by a higher magnification optical arrangement. In contradistinction, in conventional microscopes, higher resolution is achieved more by higher optical magnification. Nevertheless, small changes in optical magnification can still be an important factor in the embodiments. The goal is not always to have a high magnification. For example, an optical magnification magnitude of around 0.9 can make manufacturing much easier while trading off only a small loss of resolution compared to optical magnification magnitudes closer to or greater than 1. By way of example, in two embodiments, the values or exact points for (A/F, o) are respectively (10, 1.5) and (3, 5).

According to some embodiments, illumination unit 110 is positioned as close to lens array 130 as possible, i.e., small A, (given the aforementioned practical constraints) in order to further increase spatial resolution using non-negligible optical magnification or optical magnification significantly greater than one. In furtherance of such embodiments, sensor 140 may correspondingly be positioned as far from lens array 130 as possible, i.e., large A, in order to achieve the largest permissible optical magnification and image resolution while avoiding information loss due to overlap between adjacent sub-images and/or the total area of the sub-images exceeding the area of sensor 140. In an alternative embodiment, illumination unit 110 may be positioned far from lens array 130 (e.g., more than 10 times farther than the focal length of lenses 131-139) to reduce the sensitivity of lens array microscope 100 to small errors in the alignment and positioning of the various components. Such embodiments may increase the robustness of lens array microscope 100 when using an optical magnification less than or equal to about one. One advantage of configuring lens array microscope 100 with a small or negligible optical magnification (that is, an optical magnification less than or equal to about one) is that, in such embodiments, the lenses are less sensitive to aberrations than in a higher magnification configuration and may therefore be manufactured more cost effectively and/or in an otherwise advantageous manner (e.g., lighter, stronger, and/or the like). Another advantage of configuring microscope 100 with a small or negligible optical magnification is that, in such embodiments, microscope 100 has an unfragmented field of view. An unfragmented field of view comes from the upper bounds on the inequalities:

$$\begin{matrix}f < b \leq \frac{2 fA}{A - 2 f} and & Eq . 9 \\ 0 < o \leq \frac{A + 2 f}{A - 2 f} & Eq . 10\end{matrix}$$

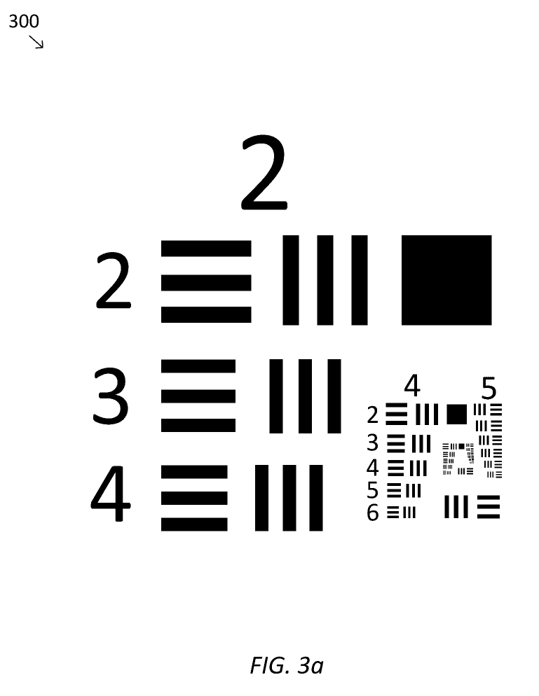

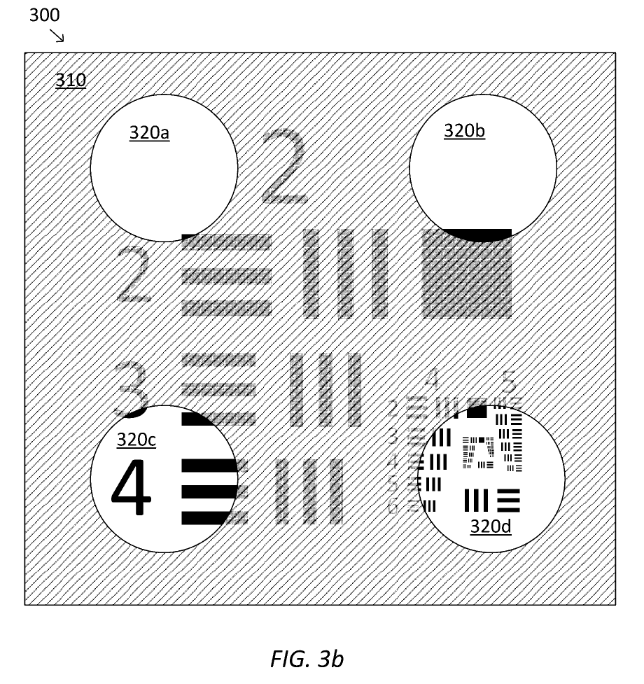

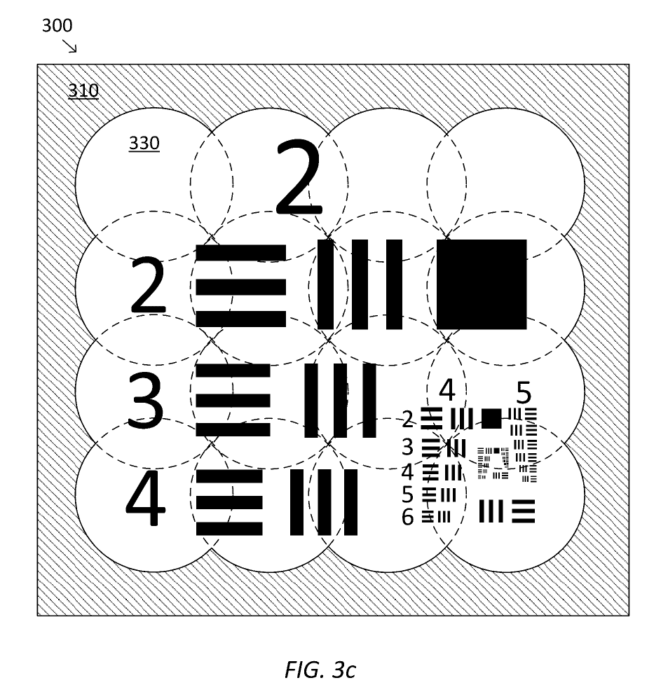

This can be achieved for relatively large optical magnifications. The distinction between a fragmented and an unfragmented field of view is described below with reference to FIG. 3A, FIG. 3B and FIG. 3C.

FIG. 3A is a diagram of a test pattern 300. FIG. 3B and FIG. 3C are simplified diagrams of images corresponding to the test pattern 300 in FIG. 3A, taken by the image sensor 140. A microscope that uses more than one lens to concurrently image multiple regions of test pattern 300 may include a plurality of objective lenses and/or a lens array, each of the lenses having a large optical magnification. In FIG. 3B, due to the large optical magnification, the field of view of each of the lenses may cover separate, non-abutting, and/or non-overlapping regions of test pattern 300. Regions 320a-d, and 330 describe the fields of view, which means the region of the sample that is viewed. The image plane may be densely covered or filled with these views even though they only represent a small subset of test pattern 300. For example assuming the light source is far away, if the magnification is m, then only 1/m² of the area of the sample can be viewed even if the entire sensor is used. Stated another way, an exemplary fragmented field of view of the microscope includes regions 320a-d of test pattern 300. Each of regions 320a-d corresponding to a field of view of a different lens. Regions 320a-d are separated from one another by a region 310 that is not imaged. A microscope with a fragmented field of view, such as the one depicted in FIG. 3B, may employ scanning techniques, stepping techniques, and/or the like during imaging in order to fill in region 320 and capture a complete image of test pattern 300. Such techniques may include acquiring a set of spatially offset images which are subsequently combined to form a seamless image of test pattern 300. However, according to some embodiments, it may be advantageous to avoid the use of scanning and/or stepping techniques, as such techniques may be time consuming, error prone, and/or computationally demanding. In order to avoid the use of such techniques, according to some embodiments, a microscope is configured to have an unfragmented field of view. In FIG. 3C, an exemplary unfragmented field of view includes a continuous region 330 of test pattern 300 that is captured within the field of view of at least one of the lenses. According to some embodiments consistent with FIG. 1C, lens array microscope 100 is configured to have an unfragmented field of view similar to FIG. 3C.

As discussed above and further emphasized here, FIG. 1A, FIG. 1B, FIG. 1C, FIG. 2A, FIG. 2B, FIG. 3A, FIG. 3B and FIG. 3C are merely examples which should not unduly limit the scope of the claims. One of ordinary skill in the art would recognize many variations, alternatives, and modifications. According to some embodiments, illumination unit 110 uses ambient light rather than, and/or in addition to, light source 111 in order to provide light to sample 120. The use of ambient light may provide various advantages such as lighter weight, compact size, and/or improved energy efficiency. Accordingly, the use of ambient light may be particularly suited for size- and/or energy-constrained applications such as mobile applications. According to some embodiments, various components of lens array microscope 100 may be included within and/or attached to a mobile device such as a smartphone, laptop computer, watch, and/or the like. For example, sensor 140 may be a built-in camera of said mobile device and image processor 150 may include hardware and/or software components that communicate with and/or run applications on said mobile device. According to some embodiments, although the unfragmented field of view shown in region 330 of FIG. 3C is depicted as being free of gaps, an unfragmented field of view may have small gaps, provided that the gaps are sufficiently small that a usable image can be obtained from a single acquisition without employing scanning techniques, stepping techniques, and/or the like. Furthermore, although the field of view of each lens is depicted as being circular in FIG. 3B and FIG. 3C, the field of view may have various shapes depending on the type of lens being used. According to some embodiments, a numerical aperture associated with lens array 130 may be increased by using a medium with a higher index of refraction than air between sample 120 and lens array 130, such as immersion oil.

According to some embodiments, lens array microscope 100 is configured to acquire monochrome and/or color images of sample 120. When microscope 100 is configured to acquire color images, one or more suitable techniques may be employed to obtain color resolution. In some examples, sensor 140 includes a color filter array over the pixels, allowing a color image to be obtained in a single image acquisition step. In some examples, a sequence of images is acquired in which illumination unit 110 provides different color lights to sample 120 during each acquisition. For example, illumination unit 110 may apply a set of color filters to a broadband light source, and/or may switch between different colored light sources such as LEDs and/or lasers. According to some embodiments, microscope 100 is configured to acquire images with a large number of colors, such as multispectral and/or hyperspectral images.

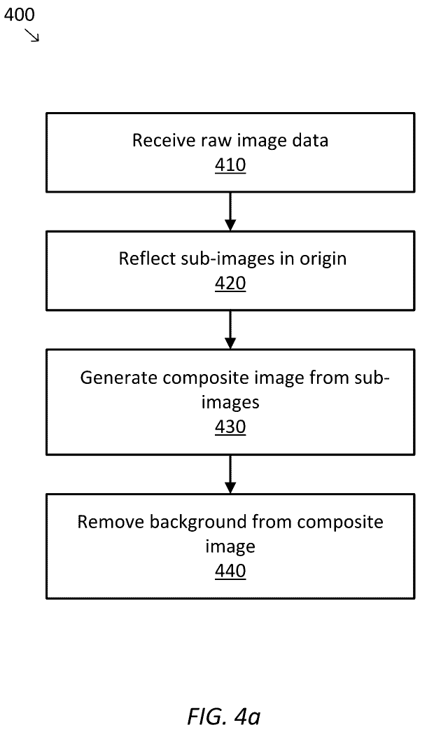

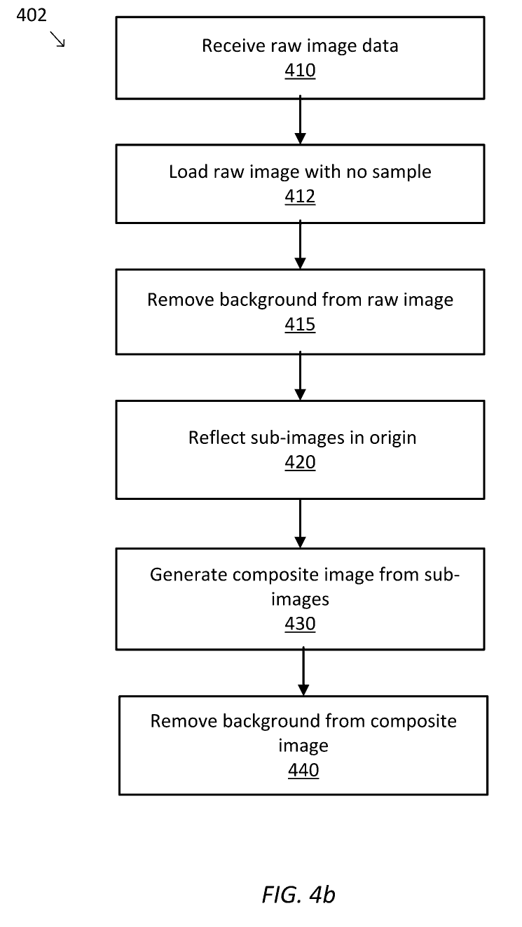

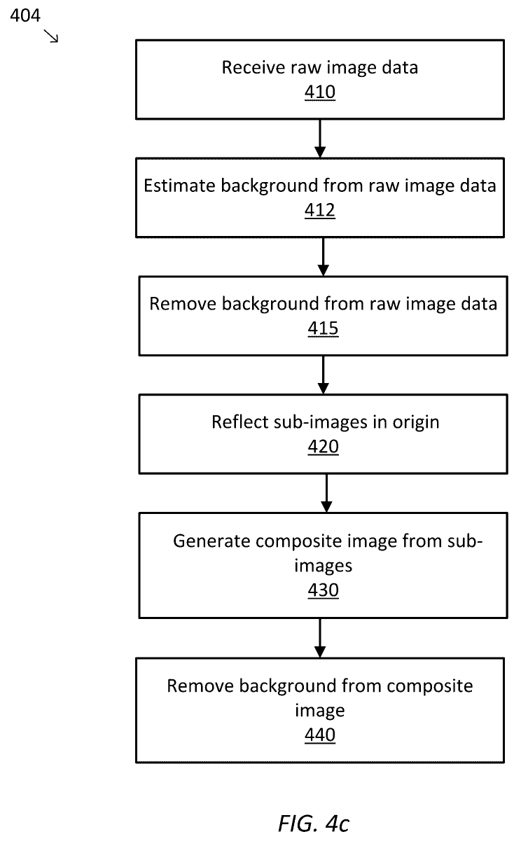

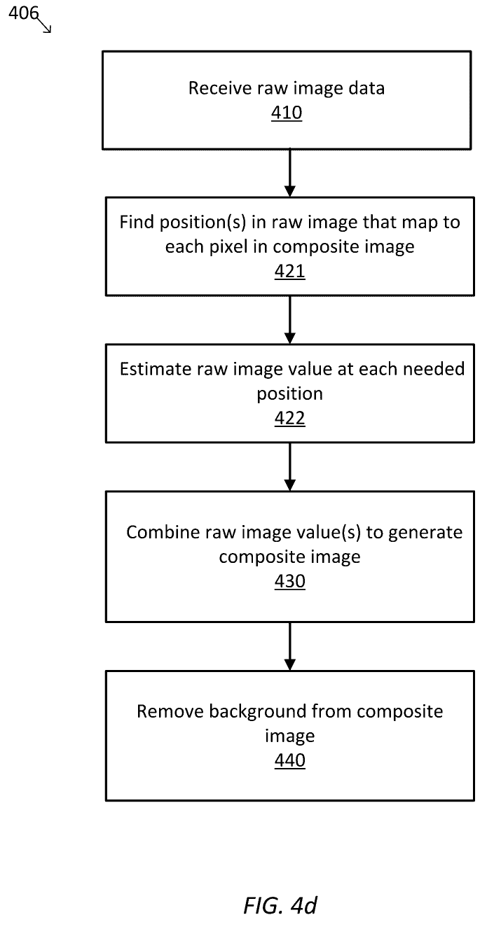

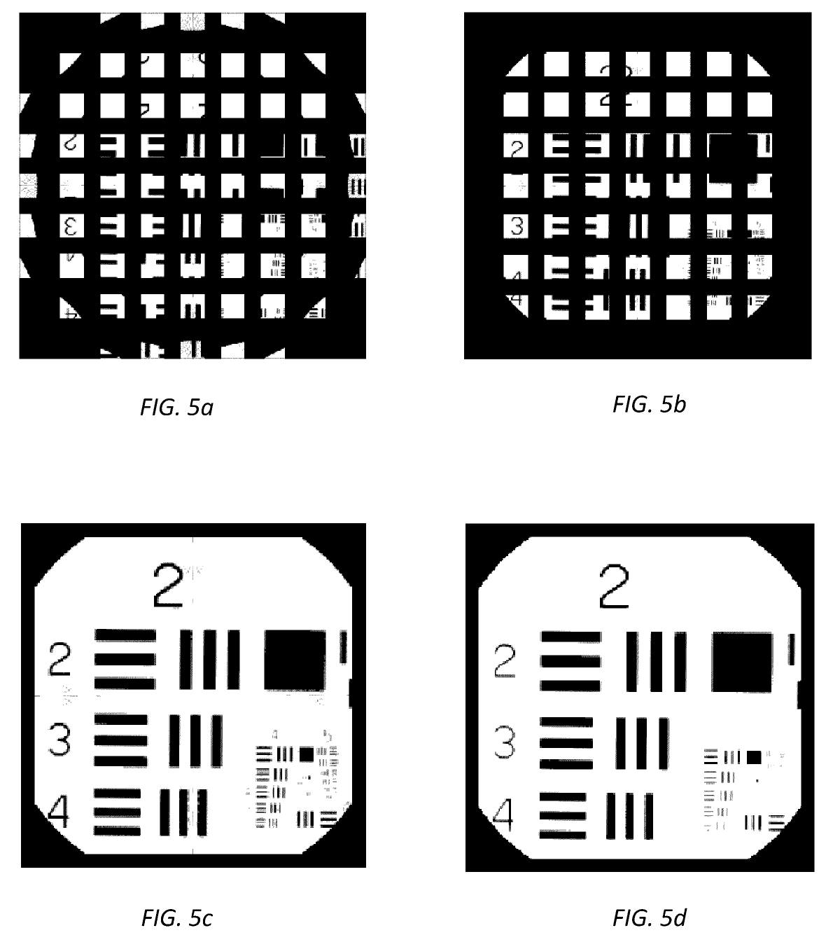

FIG. 4A is a simplified diagram of a method 400 for processing images acquired using a lens array microscope according to some examples. The method may be performed, for example, in image processor 150 and/or by a computer, a microprocessor, ASICs, FPGAs, and/or the like. Corresponding FIG. 5A, FIG. 5B, FIG. 5C and FIG. 5D are simplified diagrams of simulation data illustrating an exemplary image being processed by method 400 according to some examples. According to some embodiments consistent with FIG. 1A, FIG. 1B, FIG. 1C, FIG. 2A, FIG. 2B, FIG. 3A, FIG. 3B and FIG. 3C, microscope 100 is used to perform one or more steps of method 400 during operation. More specifically, an image processor, such as image processor 150, may perform method 400 in order to convert raw image data into output image data.

Referring to FIG. 4A, at a process 410, raw image data is received by, for example, image processor 150 from, for example, sensor 140 of the microscope of FIG. 1C or a separate memory (not shown). The raw image data may include a plurality of sub-images corresponding respectively to each of the lenses of the microscope. In some examples, the sub-images are extracted from the raw image data using appropriate image processing techniques, such as a feature extraction algorithm that distinguishes the sub-images from the dark regions that separate the sub-images, a calibration procedure that predetermines which portions of the raw image data correspond to each of the sub-images, and/or the like. According to some examples, the raw image data is received in a digital and/or analog format. Consistent with some embodiments, the raw image data may be received in one or more RAW image files and/or may be converted among different file formats upon receipt and/or during processing. Referring to FIG. 5A, an exemplary set of raw simulated image data received during process 410 is depicted.

Referring back to FIG. 4A, at a process 420, the sub-images in the raw image data are reflected in the origin or inverted about a point in a sub-image. In some examples, the sub-images in the raw image data are inverted by the optical components of the lens array microscope, so process 420 restores the correct orientation of the sub-images. According to some embodiments, the origin may be a predetermined point defined in relation to each sub-image, such as a center point of the sub-image, a corner point of the sub-image, and/or the like. According to some embodiments, the sub-images are reflected iteratively, such as by using a loop and/or nested loops to reflect each of the sub-images. According to some embodiments, the sub-images are reflected concurrently and/or in parallel with one another. According to some embodiments, the reflection is performed using software techniques and/or using one or more hardware acceleration techniques. According to some embodiments, such as when the lens array microscope is configured such that the sub-images in the raw image data are not inverted, process 420 is omitted. Referring to FIG. 5B, an exemplary set of sub-images generated by applying process 420 to the raw image data of FIG. 5A is depicted.

Referring back to FIG. 4A, at a process 430, a composite image is generated from the sub-images. According to some embodiments, process 430 may include removing dark regions between the sub-images. That is, the sub-images may be brought closer together by a given distance and/or number of pixels. In some examples, process 430 may employ various image processing techniques to obtain a seamless composite image from the sub-images, including techniques that account for overlap between adjacent sub-images. One technique is to use the value corresponding to the position closest to the origin of the sub-image. This has the advantage of using brighter positions that tend to have higher signal to noise ratios. Also these positions are less susceptible to artifacts caused by lens aberrations. According to some embodiments, process 430 may include initializing an empty composite image, then copying each sub-image into a designated portion of the composite image. For example, copying the sub-images into the composite image may be performed using iterative techniques, parallel techniques, and/or the like. Referring to FIG. 5C, an exemplary composite image generated by applying process 430 to the sub-images of FIG. 5B is depicted.

Referring back to FIG. 4A, at a process 440, a background is removed from the composite image. Here, “background” refers to image artifacts or errors in the composite image that are not present in the image of the sample. Removing the background may be done by subtraction or division by the image processor 150 (shown in FIGS. 1A, 1B and 1C). According to some embodiments, the background may include features of the composite image that are present even in the absence of a sample in the lens array microscope. Accordingly, the features of the background may represent artifacts that are not associated with a particular sample, such as irregularities in the illumination unit, lenses, and/or sensor of the lens array microscope. Because the artifacts do not provide information associated with a particular sample, it may be desirable to subtract the background from the composite image. In some examples, the background may be acquired before and/or after images of the sample are acquired (e.g., before loading and/or after unloading the sample from the microscope). According to some embodiments, the composite image is normalized relative to the background (or vice versa) such that the background and the composite image have the same intensity scale. Referring to FIG. 5D, an exemplary output image generated by applying process 440 to the composite image of FIG. 5C is depicted.

As discussed above and further emphasized here, FIG. 4A and FIGS. 5A, 5b, 5c and 5D are merely examples which should not unduly limit the scope of the claims. One of ordinary skill in the art would recognize many variations, alternatives, and modifications. According to some embodiments, one or more of processes 420-440 may be performed concurrently with one another and/or in a different order than depicted in FIG. 4A. According to some embodiments, method 400 includes additional processes that are not shown in FIG. 4a, including various image processing, file format conversion, user input steps, and/or the like. According to some embodiments, one or more of processes 420-440 is omitted from method 400.

With reference to FIGS. 4B and 4C, in some embodiments, the background is optionally removed by applying a convolutional filter at process 415, i.e., between processes 410 and 420. The convolution filter is designed to suppress any background caused by the components of lens array microscope 100 and not sample 120. For example the composite image may have undersired or high spatial frequencies corresponding with the relative position of the pixels to lens array 130. Such spatial frequencies are undesired because they are likely to be caused by the particulars of the lens array microscope and not the sample. A convolution filter is designed to remove such undesired spatial frequencies. Process 415 removes the background from the raw image based upon an image containing the background in the raw image. Different methods are used at process 415 to remove the background from the raw image such as subtraction and/or division.

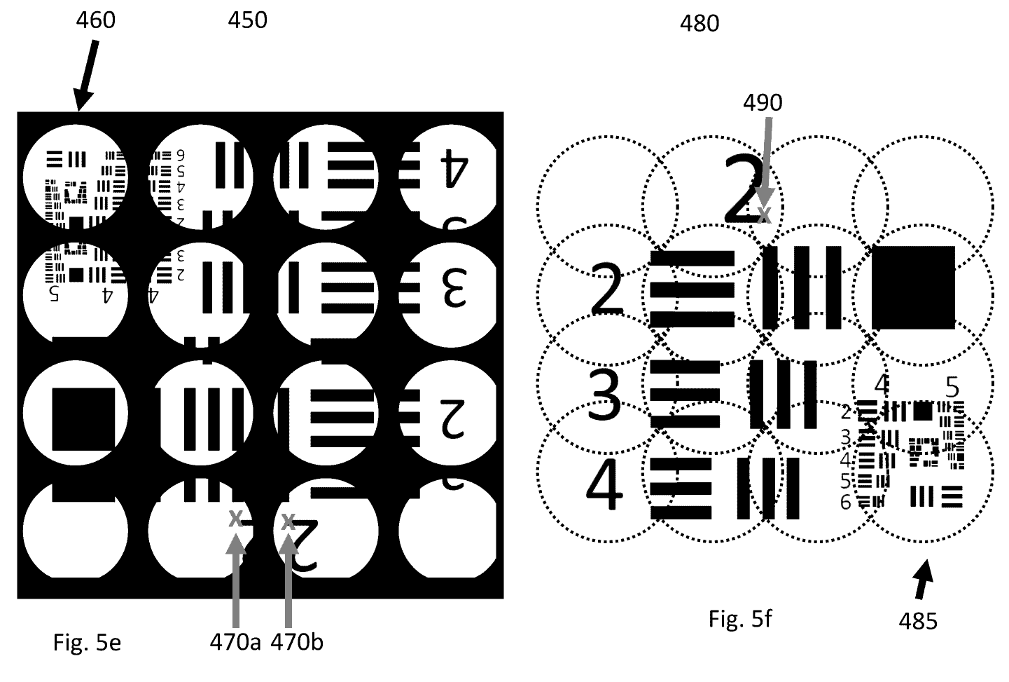

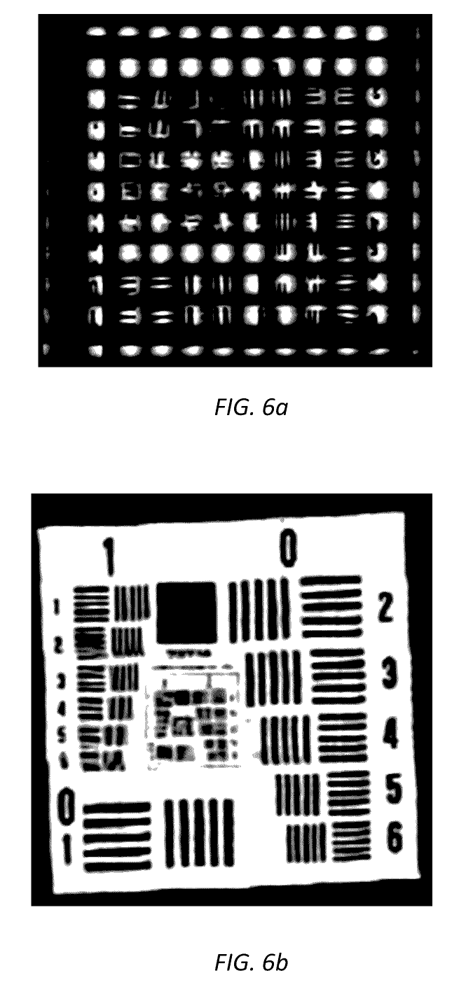

FIG. 4B is a simplified diagram of a method 402 for processing images acquired using a lens array microscope according to some examples. At a process 410, raw image data including image data of a sample is received by, for example, image processor 150 from, for example, sensor 140 of the microscope of FIG. 1A or a separate memory (not shown). The raw image data can have a “background” that includes any amplitude modulations, intensity non-uniformities, or shading in the raw image data of the sub-images that is not present in the image data of the sample. In one aspect, the shading is similar to lens shading or vignetting in other image systems. The shading over a sub-image can be caused by various aspects of the hardware configuration of the lens array microscopes. Possible contributing factors include the non-uniform incident illumination on the sensor, properties of the associated lens in the lens array, sensitivity of the image sensor to various angles of incoming light, and relative position of the lens within the lens array. This type of “background” can be seen in FIG. 6A where each sub-image appears brightest in the middle with intensity falloff on the edges.

To determine a background in the raw image data, a raw image with no sample is loaded at process 411. In other embodiments, the raw image with no sample is received before receiving the raw image data including data of a sample. Such an image with no sample may be generated experimentally by capturing an image taken with the lens array microscope 100 when no sample 120 is present. Such an image will be the result of the various components of the lens array microscope 100, which will interact in a complex manner to create the background image. In other embodiments, the background is theoretically derived in the raw image. However, in the embodiments exemplified by FIG. 4B, it is more practical to generate the image experimentally to account for the complex interaction and precise knowledge of the position and composition of the materials. Microscopic changes in the relative position or composition of the materials comprising lens array microscope 100 can have significant impact on the resultant background image. Such a raw image with no sample is loaded at process 411. FIG. 4c is a simplified diagram of another method 404 for processing images acquired using a lens array microscope according to some examples. This method can be applied to, for example, a sample on a container such as glass slide or petri dish. In such example, the container can bend the light so a raw image with no sample or no container may not capture the correct background or shading. Here, the background is estimated from the raw image or a multitude of such raw images in process 412. Since the raw image(s) are a result of both sample 120 and background resulting from the components of lens array microscope 100, process 412 needs to isolate only the background component. Different image processing and learning methods include filtering, regularization, image models, and sparsity priors may be introduced to separate these multiple components of the signal. A simple method will be described here as an example of such methods. The raw background contains a relatively-regular pattern throughout the image caused by the multiple sub-images. The sub-images can appear to have similar shapes and intensity profiles with bright regions in the center of the sub-image and darker regions near the outside of the sub-image and between nearby sub-images. By combining the multiple sub-images from throughout the image such as by averaging, a fundamental sub-image pattern is estimated. A fundamental sub-image is a single image having approximately the same shape and intensity distribution as all of the sub-images in the raw image after ignoring any variations across the sub-images based upon their position within the raw image or presence of sample 120. If the presence of sample 120 causes alterations in the raw image that are not correlated with the position of the multiple sub-images of the background raw image, the estimated fundamental sub-image pattern is unaffected by the presence of sample 120. Finally a background raw image is created as the output of process 412 by placing multiple versions of the fundamental sub-image pattern in the appropriate positions within an image.

In other embodiments, convolutional filtering is applied in step 412 across the image in order to remove the effects of sample 120. The background image should be dominated by spatial frequencies caused by the regular spacing of the lenses in lens array 130 and the resultant regular position of the sub-images. For example, spatial frequencies that have maximums near the center of each of the sub-images and minimums in the dark regions between the sub-images exist strongly in the background image but are unlikely to be caused by sample 120. Alternatively higher spatial frequencies may be caused by sample 120 but are unlikely to be caused by the regular position of the sub-images. Therefore, the background may be estimated from a raw image by applying a convolutional filter that removes frequencies that are inconsistent with the regular position of the sub-images.

FIG. 4D provides an alternate embodiment of a method 406 for processing images acquired using a lens array microscope according to some examples. The method in FIG. 4D enables sub-pixel accuracy in position and combination of sub-images, which may not be offered by the processes in FIGS. 4A, 4B and 4C. As a result, images output from FIG. 4D are more accurate and contain fewer artifacts such as blurred or discontinuous edges appearing in the composite image when the edges cross between adjacent sub-images in the raw image.

With continuing reference to FIG. 4D, process 421 finds the position(s) in the raw image for each pixel in the desired composite image. Since the fields of view of adjacent lenses in the lens array overlap, positions in the sample may appear in one or multiple sub-images. Therefore each pixel in the composite image may need to be generated from one or multiple positions in the raw image in order for the composite image to accurately reflect the sample. For example, consider FIG. 5E of a raw image 450 and FIG. 5F of a desired output composite image 480 from said raw image. Sub-image 460 is one of the multiple sub-images in the raw image. Circle 485 in the composite image shows the region of the composite image that was influenced by sub-image 460. Consider location 490 that represents a pixel in the composite image. This location represents a point in the sample that was visible in two sub-images of the raw image at positions 470a and 470b. It is possible to find the appropriate position(s) in the raw image (for example 470a and 470b) for each pixel in the composite image (for example 490) by inverting each of the mappings from positions in the raw image to the composite image (such as from position 470a or 470b to 490). The mappings from positions in the raw image (such as 470a and 470b) to the composite image (such as position 490) is already described with respect to processes 420 and 430. Specifically the mapping includes reflecting sub-images in their origin and may include moving the sub-images closer together by a given distance and/or number of pixels. By inverting the mapping for each sub-image from the raw image to the composite image, it is possible to find all of the positions in the raw image that are mapped to each pixel in the composite image. For example the inverse mapping is from pixel 490 to positions 470a and 470b.

In general the position(s) (470a and 470b) in the raw image will be non-integer pixel position values, which must be inferred from the raw image where pixel values are only obtained at whole-number pixel locations. Such values at non-integer pixel locations are necessary if sub-pixel accuracy is used to determine the origin location of each sub-image or any amount the sub-images are moved closer together, which is necessary to increase accuracy and reduce artifacts from the composite image. For this reason it is often necessary to estimate the raw image value at each needed position as performed in process 422. If non-integer positions are needed, other embodiments can use a variety of methods known to one skilled in the art of performing such estimation or sub-pixel interpolation. These methods include linear interpolation, polynomial interpolation, and splines.

With reference back to FIG. 4D, process 431 combines the raw image value(s) obtained for each pixel in the composite image. Such combination may include a variety of methods including the ones listed above for process 430, which may be preferred based on the particulars of the sample or components of the lens array microscope. One of the methods is to use the value corresponding to the position closest to the origin of the sub-image. Again, this has the advantage of using brighter positions that tend to have higher signal to noise ratios. Also these positions are less susceptible to artifacts caused by lens aberrations.

In other embodiments, process 431 generates the composite image by using a weighted average of the raw image value(s). For example, if the weights are equal, the composite image value is the mean of the raw image value(s) which makes the composite image have less noise due to the improved signal to noise ratio of averaging. Alternatively the weights may vary based upon the position in the composite image so that positions in the raw image closer to the origin of their respective image are given increased weight. This results in smooth transitions between the various regions in the composite image (such as 485). This is important if there are parts of sample 120 that modulate the light and are away from the focal plane determined by the lens array and the image plane of the image sensing unit. Such parts of sample 120 away from the focal plane will appear as blurred in the composite image. This may be preferable to the appearance of such parts of sample 120 in the composite image as sharp objects that have an abrupt change in position when using the previously-described embodiments where the composite image is taken from the position closest to the origin of the sub-image.

FIG. 6A and FIG. 6B are images showing experimental data illustrating an exemplary image before and after being processed by method 400 according to some examples. In FIG. 6A, raw input data corresponding to a test sample is depicted Like the simulation data depicted in FIG. 5A, a plurality of sub-images separated by dark regions may be identified. In addition, various non-idealities that are not present in the simulation data of FIG. 5A may be observed in FIG. 6A. For example, the sub-images in the experimental data appear slightly rounded and have blurred edges relative to the simulation data. In FIG. 6B, an output image obtained by applying method 400 to the raw input data of FIG. 6A is depicted. As depicted, the output image is observed to depict the test sample with high resolution.

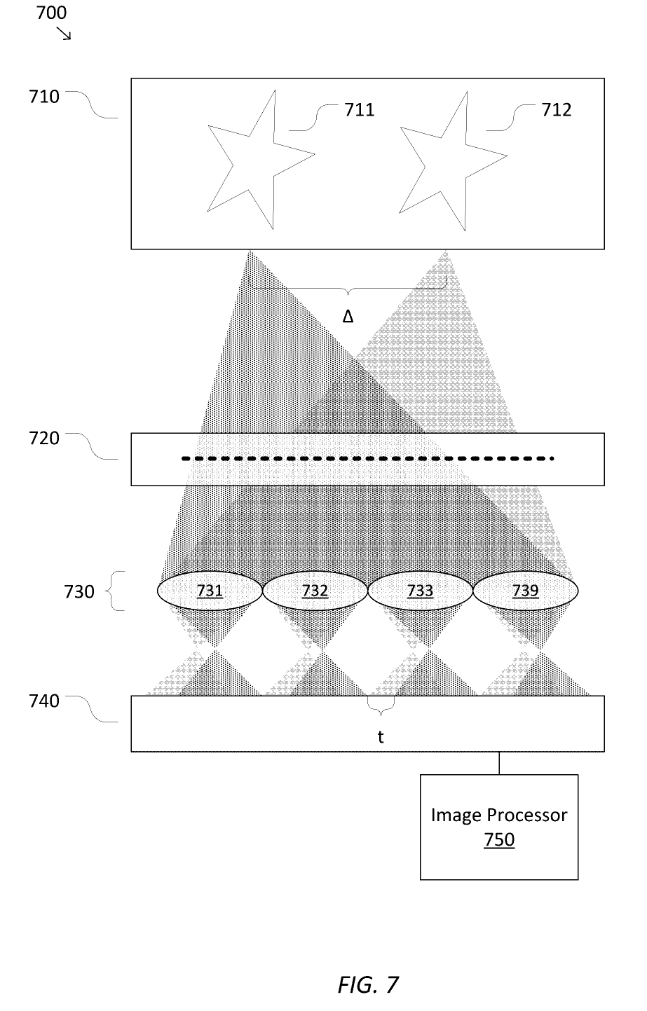

FIG. 7 is a simplified diagram of a lens array microscope 700 with a non-point light source according to some embodiments. Like microscope 100 as depicted in FIGS. 1A, 1B and 1C, lens array microscope 700 includes an illumination unit 710, sample 720, lens array 730 including lenses 731-739, sensor 740, and image processor 750. However, unlike microscope 100, illumination unit 710 includes a non-point light source represented by a pair of light sources 711 and 712. According to some embodiments, illumination units 711 and 712 may be viewed as two separate light sources separated by a distance A. According to some embodiments, illumination units 711 and 712 may be viewed as a single light source having a width A. In some examples, the light emitted by light sources 711 and 712 may have the same and/or different characteristics from one another, such as the same and/or different color, phase, polarization, coherence, and/or the like. Although a pair of light sources 711 and 712 are depicted in FIG. 7, it is to be understood that illumination unit 710 may include three or more illumination units according to some embodiments.

According to some embodiments, such as when light sources 711 and 712 are not coherent with one another, each sub-image captured by microscope 700 may be the sum of sub-images associated with each of light sources 711 and 712. Because light sources 711 and 712 are spatially separated, the sub-images associated with the light sources 711 and 712 are offset relative to one another at sensor 750 by a distance t, as depicted in FIG. 7. By applying the lens equations derived with respect to FIGS. 1A, 1B and 1C, it can be shown that the value of t is given by the equation

$$t = \frac{b}{A} Δ .$$

According to some embodiments, illumination unit 710 may be designed to avoid sub-images from different lenses 731-739 from overlapping at sensor 740. Such overlapping may be undesirable because the overlapping images may not easily be separated, resulting in a loss of information and/or degradation of image quality. Overlapping occurs when t exceeds d (the width of the dark region between sub-images produced by a single point light source). Accordingly, in order to avoid overlapping, the value of A may be constrained according to the following equation:

$$Δ \leq \frac{Ad}{b} = \frac{A ( M - m ) p}{b} = ( \frac{2 A}{b} - \frac{A}{f} + 2 ) p \qquad Eq . 11$$

Based on this constraint, the non-point light source of illumination unit 710 may be designed such that the light originates from a circle having a diameter Δₜ, where Δₜ is the maximum allowable value of A that satisfies the above inequality. According to some embodiments, this constraint may be satisfied in a variety of ways, such as by using small light sources 711 and 712, configuring one or more diaphragms and/or lenses of illumination unit 710, positioning light sources 711 and 712 far from lens array 730, positioning lens array 730 close to sensor 740, and/or the like.

As discussed above and further emphasized here, FIG. 7 is merely an example which should not unduly limit the scope of the claims. One of ordinary skill in the art would recognize many variations, alternatives, and modifications. For example, although light sources 711 and 712 are depicted as being in the same plane as one another relative to the sample plane, light sources 711 and 712 may be positioned at different distances relative to sample 720. In furtherance of such embodiments, various modifications to the above equations may be made in order to derive an appropriate value of Δₜ.

Some examples of controllers, such as image processors 150 and 750 may include non-transient, tangible, machine readable media that include executable code that when run by one or more processors may cause the one or more processors to perform the processes of method 400. Some common forms of machine readable media that may include the processes of method 400 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A microscope comprising:
an illumination unit;
an image sensor at an image plane; and
a lens array including a plurality of lenses generally in a lens plane, the lens array having a focal plane (i) between the illumination unit and the lens array and (ii) corresponding to the image plane;
wherein the plurality of lenses has an unfragmented field of view including a part of the focal plane.

2. The microscope of claim 1, wherein the illumination unit includes one or more of a lens, a diaphragm, a mask, and a diffuser.

3. The microscope of claim 1, wherein a plurality of sub-images corresponding to the plurality of lenses are formed at the image sensing side of the image sensor.

4. The microscope of claim 3, wherein the plurality of sub-images do not overlap.

5. The microscope of claim 3, further comprising an image processing unit, wherein the image processing unit is configurable to:
receive first image data including image data of a sample from the image sensor, the image data including the plurality of sub-images;
receive second image data having no image data of the sample;
remove background from the first image data;
reflect at least one of the sub-images in the origin; and
generate a composite image from the plurality of sub-images, the composite image corresponding to the unfragmented field of view.

6. The microscope of claim 3, further comprising an image processing unit, wherein the image processing unit is configurable to:
receive image data from the image sensor, the image data including the plurality of sub-images;
estimate background from the raw image data;
remove background from the raw image data;
reflect at least one of the sub-images in the origin; and
generate a composite image from the plurality of sub-images, the composite image corresponding to the unfragmented field of view.

7. The microscope of claim 3, further comprising an image processing unit, wherein the image processing unit is configurable to:
receive image data from the image sensor, the image data including the plurality of sub-images;
find at least one position in the image data that maps to each pixel in a composite image corresponding to the unfragmented field of view;
estimate a plurality of image values at a plurality of positions in the composite image;
combine the plurality of raw image values;
generate the composite image from the combined plurality of raw image values; and
remove background from the composite image.

8. A microscope comprising:
a lens array, the lens array including a plurality of lenses;
an illumination unit for illuminating a sample between the illumination unit and the lens array; and
an image sensing unit;
wherein:
the image sensing unit is at an image plane of the lens array and the sample is at a corresponding focal plane of the lens array ; and
$$f < b \leq \frac{2 fA}{A - 2 f}$$
where:
f is a focal length of the plurality of lenses;
b is a distance between the lens array and the image sensing unit; and
A is a distance between the lens array and the illumination unit.

9. The microscope of claim 8, wherein a plurality of sub-images corresponding to the plurality of lenses are formed at an image sensing side of the image sensing unit.

10. The microscope of claim 9, further comprising an image processing unit, wherein the image processing unit is configurable to:
receive first image data including image data of a sample from the image sensing unit, the image data including the plurality of sub-images;
receive second image data having no image data of the sample;
remove background from the first image data;
reflect at least one of the sub-images in the origin; and
generate a composite image from the plurality of sub-images.

11. The microscope of claim 9, further comprising an image processing unit, wherein the image processing unit is configurable to:
receive image data from the image sensing unit, the image data including the plurality of sub-images;
estimate background from the raw image data;
remove background from the raw image data;
reflect at least one of the sub-images in the origin; and
generate a composite image from the plurality of sub-images.

12. The microscope of claim 9, further comprising an image processing unit, wherein the image processing unit is configurable to:
receive image data from the image sensing unit, the image data including the plurality of sub-images;
find at least one position in the image data that maps to each pixel in a composite image;
estimate a plurality of image values at a plurality of positions in the composite image;
combine the plurality of raw image values;
generate the composite image from the combined plurality of raw image values; and
remove background from the composite image.

13. A microscope comprising:
a microlens array, the microlens array including a plurality of microlenses;
an illumination unit for illuminating a sample positioned between the illumination unit and the lens array; and
an image sensor;
an image processing unit configurable to: receive first image data including image data of a sample from the image sensor, the image data including a plurality of sub-images; receive second image data including no image data of the sample; remove background from the first image data; reflect at least one of the sub-images in the origin; and generate a composite image from the plurality of sub-images;
wherein the image sensor is at an image plane of the microlens array and the sample is at a corresponding focal plane of the microlens array.

14. A microscope comprising:
a microlens array, the microlens array including a plurality of microlenses;
an illumination unit for illuminating a sample positioned between the illumination unit and the lens array; and
an image sensor;
an image processing unit configurable to: receive image data from the image sensor, the image data including a plurality of sub-images; estimate background from the raw image data; remove background from the raw image data; reflect at least one of the sub-images in the origin; and generate a composite image from the plurality of sub-images;
wherein the image sensor is at an image plane of the microlens array and the sample is at a corresponding focal plane of the microlens array.

15. A microscope comprising:
a microlens array, the microlens array including a plurality of microlenses;
an illumination unit for illuminating a sample positioned between the illumination unit and the lens array; and
an image sensor;
an image processing unit configurable to: receive image data from the image sensor, the image data including a plurality of sub-images; find at least one position in the image data that maps to each pixel in a composite image estimate a plurality of image values at a plurality of positions in the composite image; combine the plurality of raw image values; generate the composite image from the combined plurality of raw image values; and remove background from the composite image;
wherein the image sensor is at an image plane of the microlens array and the sample is at a corresponding focal plane of the microlens array.
